(19) United States
(12) Patent Application Publication
(10) Pub. No.: US 2013/0048292 A1
(43) Pub. Date: Feb. 28, 2013

(54) METHOD OF USING FRACTURING FLUIDS CONTAINING CARBOXYALKYL TAMARIND

(71) Applicants: D. V. Satyanarayana Gupta, The Woodlands, TX (US); Kay Elaine Cawiezel, Fulshear, TX (US); Tanhee A. Galindo, Spring, TX (US)

(72) Inventors: D. V. Satyanarayana Gupta, The Woodlands, TX (US); Kay Elaine Cawiezel, Fulshear, TX (US); Tanhee A. Galindo, Spring, TX (US)

(21) Appl. No.: 13/217,086

(22) Filed: Aug. 24, 2011

(51) Int. Cl. E21B 43/26; C09K 8/62

(52) U.S. Cl. 166/308.1; 507/268

(57) ABSTRACT

The production of hydrocarbons from a hydrocarbon bearing formation is enhanced by introduction into the formation an aqueous fluid containing a carboxyalkyl tamarind powder. The fluid may be linear or crosslinked.

### FIELD OF THE INVENTION

The invention relates to a method of enhancing the productivity of a hydrocarbon-bearing subterranean formation by use of a well treatment fluid containing carboxyalkyl tamarind.

### BACKGROUND OF THE INVENTION

Hydraulic fracturing is used to create subterranean fractures that extend from the borehole into the rock in order to increase the rate at which fluids can be produced from the formation. Generally, a fracturing fluid is pumped into the well at high pressure. Once natural reservoir pressures are exceeded, the fracturing fluid initiates a fracture in the formation which continues to grow during pumping. The treatment design generally requires the fluid to reach maximum viscosity as it enters the fracture.

The fracturing fluid typically contains a proppant which is placed within the produced fracture. The proppant remains in the produced fracture to prevent the complete closure of the fracture and to form a conductive channel extending from the wellbore into the treated formation.

Most fracturing fluids contain a viscosifying agent in order to increase the capability of proppant transport into the fracture. Viscosifying agents which are widely used in hydraulic fracturing are guar gum (galactomannans) and guar gum derivatives. Exemplary guar or guar gum derivatives include hydroxypropyl guar (HPG), carboxymethyl guar (CMG) and carboxymethylhydroxypropyl guar (CMHPG) as well as high molecular weight non-derivatized guar.

Once the high viscosity fracturing fluid has carried the proppant into the formation, breakers are used to reduce the fluid's viscosity. In addition to facilitating settling of the proppant in the fracture, the breaker also facilitates fluid flowback to the well. Breakers work by reducing the molecular weight of the galactomannans. The fracture then becomes a high permeability conduit for fluids and gas to be produced back to the well.

Common breakers for use in fracturing fluids include chemical oxidizers, such as hydrogen peroxide, magnesium peroxide, calcium peroxide, zinc peroxide, and persulfates breakers. In addition, the breaker may be an enzymatic breaker. Typically, the enzyme breaker system is a mixture of highly specific enzymes which, for all practical purposes, completely degrade the backbone of the polymer which is formed.

It is desirable that the fracturing fluid be less viscous and has relatively low friction pressures in order to minimize tubular friction pressures as the fluid is pumped into the wellbore and into the formation. In addition, fracturing fluids having relatively low friction pressures reduce the amount of energy required to pump the fluid through tubing.

Guar and guar gum derivatives are principally created from the endosperm (or guar seed) of guar gum bean. The endosperm goes through a complicated milling process which includes dehusking, milling and screening to obtain the guar gum. The guar plant grows best in sandy soils in the semiarid regions of the world, principally in India and Pakistan. In light of the increased use of guar and guar gum derivatives in industry, there is often a shortage in supply. The shortages also increase the costs of the product. Alternatives have therefore been sought for guar and guar gum derivatives as viscosifying agents for use in oil and gas fields.

### SUMMARY OF THE INVENTION

The invention relates to a method for enhancing the production of a hydrocarbon bearing formation by introducing into the hydrocarbon-bearing formation a fluid containing a carboxyalkylated tamarind. The carboxyalkylated tamarind acts as the viscosifying polymer or gelling agent.

The alkyl of the carboxyalkyl group of the carboxyalkylated tamarind may be a C₁-C₆ alkyl. In an embodiment, the carboxyalkyl group of the carboxyalkylated tamarind is either carboxymethyl, carboxyethyl, carboxypropyl or carboxybutyl. In a preferred embodiment, the carboxyalkyl tamarind powder is carboxymethyl tamarind.

The fluid may be linear (non-crosslinked).

Alternatively, the fluid may be crosslinked or contain a crosslinking agent.

The use of carboxyalkyl tamarind in the fluid decreases the friction of the aqueous fluid even without the addition of a friction reduction agent in the fluid.

### BRIEF DESCRIPTION OF THE DRAWINGS

In order to more fully understand the drawings referred to in the detailed description of the present invention, a brief description of each drawing is presented, in which:

FIG. 1 illustrates viscosity over time of a linear fluid containing carboxymethyl tamarind.

FIG. 2 demonstrates friction reduction versus time of a linear fluid containing carboxymethyl tamarind.

FIG. 3 illustrates viscosity over time of a crosslinked fluid containing carboxymethyl tamarind.

### DETAILED DESCRIPTION OF THE PREFERRED EMBODIMENTS

The gelling agent defined herein is a carboxyalkyl tamarind. The alkyl of the carboxyalkyl group is typically a C₁-C₆ alkyl group. Exemplary carboxyalkyl groups include carboxymethyl, carboxyethyl, carboxypropyl and carboxybutyl. Carboxymethyl tamarind is most preferred.

The well fracturing fluid of the invention includes an aqueous base fluid and the carboxyalkyl tamarind.

The aqueous base fluid may be, for example, water or brine.

Any suitable mixing apparatus may be used for blending carboxyalkyl tamarind powder into the aqueous fluid. In the case of batch mixing, the carboxyalkylated tamarind may be added to the aqueous fluid and then mixed for the requisite time to form the fluid.

Typically, the amount of carboxyalkyl tamarind powder added to the aqueous fluid is between from about 10 to about 500 pounds per thousand gallons (ppt) of the fluid and is more typically between from about 30 to about 100 pounds per thousand gallons (ppt).

The fluid may be a linear (non-crosslinked) fluid. When the fluid is linear, the viscosity of the linear gel is typically between from about 5 to 30 cP at 511 sec⁻¹.

The fluid may further be crosslinked or crosslinkable. When it is desired that the fluid be crosslinked, the fluid further contains a crosslinking agent. The crosslinking agent may be blended into the aqueous fluid containing the carboxyalkyl tamarind powder to form a polymer gel.

Further, breakers, crosslinking delaying agents and the other additives described herein which may optionally be included in the fracturing fluid, may be blended, with the optional crosslinking agent, into the aqueous fluid containing the carboxyalkyl tamarind.

When the fluid is crosslinked, the viscosity of the crosslinked fluid which is introduced into the well or formation is typically greater than 100 cP at 100 sec⁻¹ at temperatures up to 150° F.

Preferred crosslinking agents are those which are heat or time activated. Trivalent or higher polyvalent metal ion containing crosslinking agents are preferred. Examples of the trivalent or higher polyvalent metal ions include boron, titanium, zirconium, aluminum, yttrium, cerium, etc. or a mixture thereof. Boron, titanium and zirconium are preferred. Examples of titanium salts include titanium diisopropoxide bisacetyl aminate, titanium tetra(2-ethyl hexoxide), titanium tetraisopropoxide, titanium di(n-butoxy) bistriethanol aminate, titanium isopropoxyoctylene glycolate, titanium diisopropoxy bistriethanol aminate and titanium chloride. Examples of zirconium salts include zirconium ammonium carbonate, zirconium chloride, sodium zirconium lactate, zirconium oxyacetate, zirconium acetate, zirconium oxynitrate, zirconium sulfate, tetrabutoxyzirconium (butyl zirconate), zirconium mono(acetylacetonate), zirconium n-butyrate and zirconium n-propylate. In a preferred embodiment, the crosslinking agent contains zirconium or is a zirconium salt.

Other examples of typical crosslinking agents include, but are not limited to, those described in U.S. Pat. No. 4,514,309 and U.S. Pat. No. 5,247,995, which are incorporated herein by reference. Other examples include those having a source of comprise a source of borate ions. Such crosslinking agents may be selected from the group consisting of alkali metal borates, alkaline earth metal borates, boric acid, borate ores, borates complexed to organic compounds, probertite, ulexite, nobleite, frolovite, colemanite, calcined colemanite, priceite, pateroniate, hydroboractie, kaliborite, or combinations thereof and mixtures thereof.

The crosslinking agent may optionally be encapsulated.

Typically, the amount of crosslinking agent used in the fracturing fluid is between from about 0.001% to 1.5%, preferably from about 0.005% to 1.0%, by weight of the aqueous fluid.

The fracturing fluid may also be buffered to a desired pH range. The pH range can be adjusted with any number of available buffers of the type commonly used in the industry, such as potassium carbonate or mixtures of potassium carbonate and potassium hydroxide for high pH and mixtures of sodium acetate and acetic acid for low pH. The optimum pH range for high pH fluid is from about 8.5 to 11.5, most preferably from about 9.0 to 10.5 and for low pH fluid is from about 3.5 to 5.5, most preferably from about 4.5 to 5.0.

The fracturing fluid may further contain a breaker. The breaker is used to assist in removal or breakdown of the fracturing fluid upon completion of the fracturing operation. Breakers can include any of those commonly employed in the art.

The fluids described herein may further contain between from about 0.5 to about 7 wt. % of KCl or 0.5 to 8% NaCl. The presence of the salt has been seen to reduce the amount of viscosity yield of the carboxyalkyl tamarind powder which results in an approximate 2 to 5 cP viscosity reduction.

The fracturing fluids of the invention may also have incorporated therein a suitable proppant. Propping agents are typically added to the base fluid prior to the addition of the crosslinking agent. Suitable proppants include those conventionally known in the art including quartz, sand grains, glass beads, aluminum pellets, ceramics, plastic beads and ultra lightweight (ULW) particulates such as ground or crushed shells of nuts like walnut, coconut, pecan, almond, ivory nut, brazil nut, etc.; ground and crushed seed shells (including fruit pits) of seeds of fruits such as plum, olive, peach, cherry, apricot, etc.; ground and crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc. Further the proppant may include porous ceramics or organic polymeric particulates. The porous particulate material may be treated with a non-porous penetrating material, coating layer or glazing layer. For instance, the porous particulate material may be a treated particulate material, as defined in U.S. Patent Publication No. 20050028979 wherein (a) the ASG of the treated porous material is less than the ASG of the porous particulate material; (b) the permeability of the treated material is less than the permeability of the porous particulate material; or (c) the porosity of the treated material is less than the porosity of the porous particulate material. When present, the amount of proppant in the well treatment fluid is typically between from about 0.5 to about 12.0, preferably between from about 1 to about 8.0, pounds of proppant per gallon of well treatment fluid.

The base fluid can also contain other conventional additives common to the well service industry such as surfactants, corrosion inhibitors, and the like. For instance, the fluid may contain one or more treatment agents used to control fines or clay swelling or migration such as clay control additives of the type based on tetramethylammonium chloride, or choline chloride or polycationic clay control additives such as BJ Services' Claymaster 5C, or mixtures of these clay control additives.

In addition, the aqueous fluid may further contain a crosslinking delaying agent. The amount of crosslinking delaying agent in the aqueous fluid will vary based on design. Suitable crosslinking or viscosification delaying agents may include organic polyols, such as sodium gluconate; sodium glucoheptonate, sorbitol, mannitol, phosphonates, bicarbonate salt, salts, various inorganic and weak organic acids including aminocarboxylic acids and their salts (EDTA, DTPA, etc.) and citric acid and mixtures thereof. Preferred crosslinking delaying agents include various organic or inorganic acids, sorbitol as well as mixtures thereof. Such crosslinking delaying agents, when used, are typically desirous to delay or inhibit the effects of the crosslinking agent and thereby allow for an acceptable pump time of the well treatment composition at lower viscosities. Thus, the crosslinking delaying agent inhibits crosslinking of the polysaccharide until after the well treatment composition is placed at or near desired location in the wellbore. In this capacity, the crosslinking delaying agent may be used in lieu of, or in addition to, the delayed viscosification agents referenced above.

The fracturing fluid is pumped into a subterranean formation, which is penetrated by a wellbore, for a time and at a pressure sufficient to fracture the formation. As used herein, “introduced into a wellbore” includes pumping, injecting, pouring, releasing, displacing, spotting, circulating or otherwise placing a material within a well or wellbore using any suitable method known in the art.

Since the carboxyalkyl tamarind powder also acts as a friction reducer, it is typically not necessary to add a second friction reducer to the fluid. A fluid containing about 30 ppt of carboxyalkyl tamarind powder typically exhibits from about 25 to about 60% friction reduction when evaluated in a small friction loop.

The well treated herein may include oil wells, gas wells, coal bed methane wells and geothermal wells.

### EXAMPLES

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of weight units except as may otherwise be indicated.

### Example 1

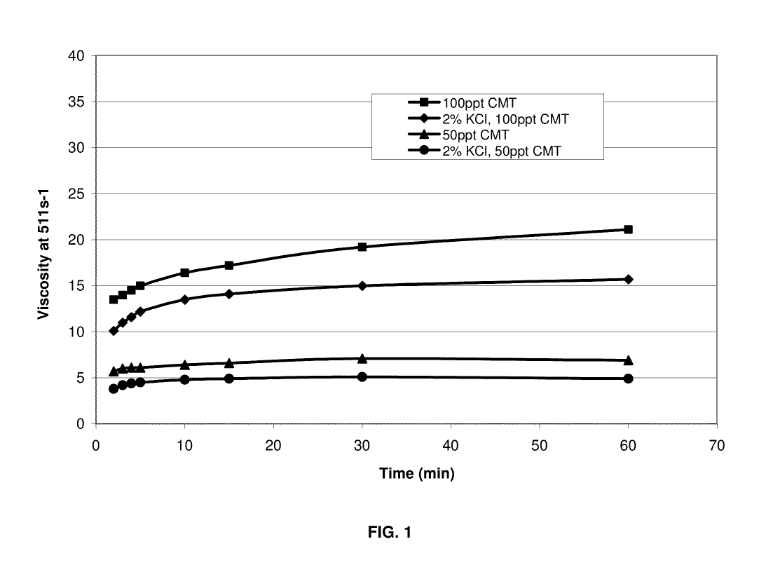

An aqueous fluid was prepared by adding 50 pounds per thousand gallons (ppt) or 100 ppt dry carboxymethyl tamarind powder (CMT) to water and, optionally 2% KCl, and mixing for 10 seconds using a standard Servodyne overhead mixer set at 1500 rpm at room temperature. The contents were then poured into an OFITE sample cup. The fluid was hydrated for 1 hour and the viscosity of the linear gel was determined at 511 sec⁻¹ on a Model 900 viscometer, commercially available from OFI Testing Equipment, Inc. (OFITE). The fluid containing 50 ppt and 100 ppt carboxymethyl tamarind powder in water had 7 and 21 cP viscosity at 511 sec⁻¹, respectively. The results are illustrated in FIG. 1 and suggest that the addition of KCl reduced the viscosity yield and resulted in 2-5 cP lower viscosity.

### Example 2

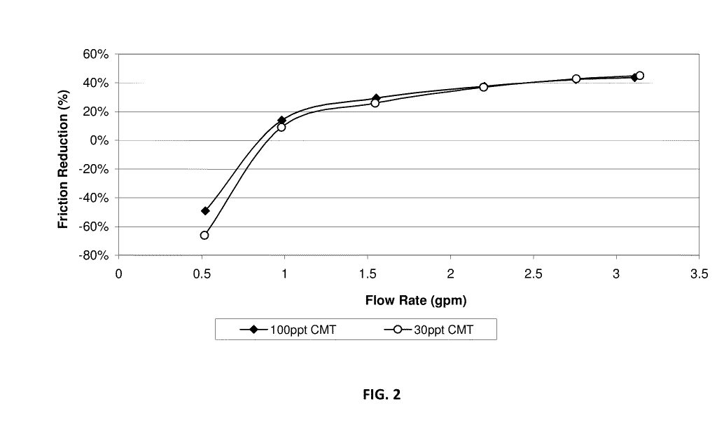

The amount of friction reduction of the aqueous fluid of Example 1 relative to water was determined. The friction loop was comprised of a small positive displacement pump having a range of 0.5-3.25 gallons per minute (gpm); a pressure gauge, and 20 ft of ¼″ tube coiled in a circle of 1.5 ft diameter. The fluid was circulated from a tank into the pump via a large ½″ stainless steel tube through the 20 ft section of coiled tubing and returned into the top of the same tank. The test fluid was re-circulated through the coil continuously throughout the test. The test volume was approximately 3000 mL of fluid. The fluid was first circulated at approximately 3 gpm for 90 seconds of the test, the flow rate was then decreased in equal increments down to 0.5 gpm. The results are illustrated in FIG. 2 and suggest that at flow rates below 1 gpm the added fluid viscosity outweighed any friction reduction compared to water. From 1 to 3 gpm, a 10-45% friction reduction was obtained with friction reduction for both fluids being comparable.

### Example 3

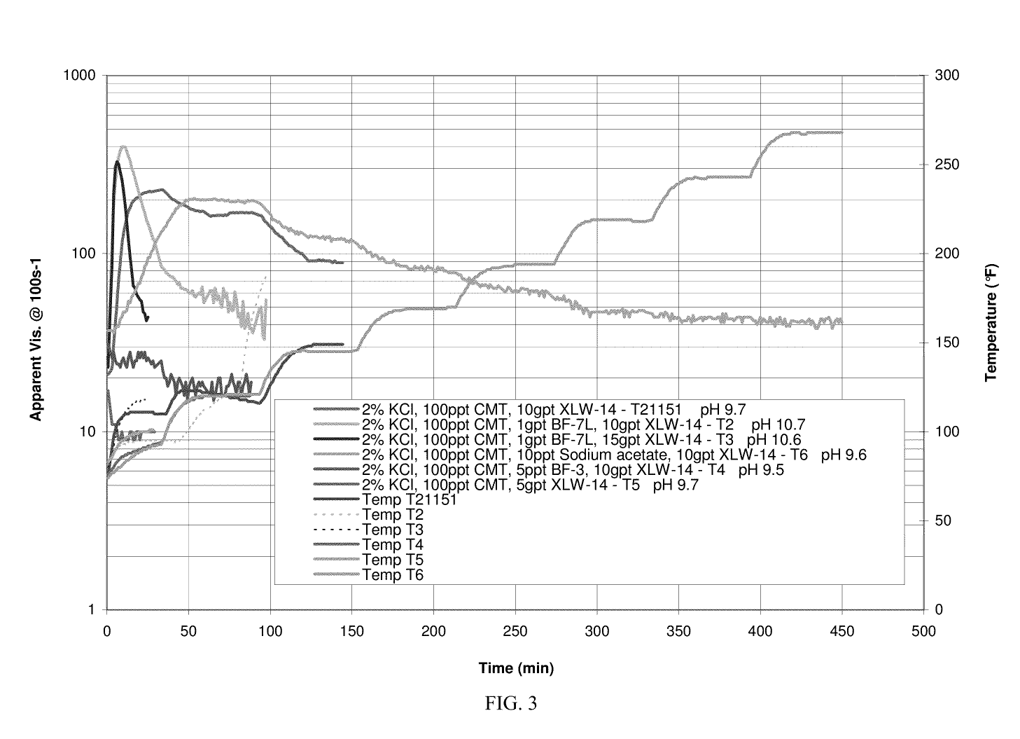

A crosslinked fluid containing 100 ppt carboxymethyl tamarind powder, optionally with 2% KCl, and a buffer (either sodium acetate or a buffer commercially available as BF-7L or BF-3 from Baker Hughes Incorporated) was tested at a temperature between 100° F. to 250° F. The fluid further contained 5 gallons per thousand (gpt), 10 gpt, or 15 gpt of zirconium crosslinker, commercially available as XLW-14 from Baker Hughes Incorporated. Carboxymethyl tamarind powder was mixed with water at room temperature for approximately 1 hour in order to hydrate the carboxymethyl tamarind powder. Buffer and crosslinker were then added to prepare the crosslinked gel. A sample of the gel was then placed into a Fann 50C viscometer cup and the cup placed on a Fann 50C viscometer. The fluid was initially sheared at 100 sec⁻¹ followed by a shear rate sweep of 40, 60, 80, and 100 sec⁻¹ to determine the power law indices n and K′. The fluid was sheared at 100 sec⁻¹ in between shear rate sweeps and the sweeps were repeated every 30 minutes. The temperature was set to 100° F. for 30 minutes and then temperature was ramped up 25° F. every 60 minutes. The temperature range was between from 100° F. to 250° in 25° F. increments. The results are shown in FIG. 3. With 2% KCl, 100 ppt carboxymethyl tamarind powder and 10 gpt crosslinker (with no additional buffer) (“T1”) a stable fluid is obtained at temperatures up to 125° F. It was noted that the addition of the carboxymethyl tamarind powder to water resulted in a final pH of approximately 9.7. The addition of buffer to the system resulted in higher early time viscosity, but did not result in a stable fluid at 100° F. The pH of the fluid was approximately 10.4.

From the foregoing, it will be observed that numerous variations and modifications may be effected without departing from the true spirit and scope of the novel concepts of the invention.

What is claimed is:

1. A method for enhancing the productivity of a hydrocarbon-bearing formation penetrated by a well which comprises pumping into the well an aqueous fluid comprising carboxyalkyl tamarind powder.

2. The method of claim 1, wherein the carboxyalkyl tamarind powder is a carboxylated C₁-C₆ alkyl tamarind powder.

3. The method of claim 2, wherein the carboxyalkyl tamarind powder is a carboxymethyl, carboxyethyl, carboxypropyl or carboxybutyl tamarind powder.

4. The method of claim 3, wherein the carboxyalkyl tamarind powder is carboxymethyl tamarind powder.

5. The method of claim 1, wherein the aqueous fluid is a linear gel.

6. The method of claim 5, wherein the viscosity of the linear gel is between from about 5 to 30 cP at 511 sec⁻¹.

7. The method of claim 1, wherein the aqueous fluid is crosslinked or contains a crosslinking agent.

8. The method of claim 7, wherein the crosslinking agent contains boron, titanium, zirconium, aluminum, ytrrium, cerium, or a mixture thereof.

9. The method of claim 8, wherein the crosslinking agent contains boron, titanium, zirconium, or a mixture thereof.

10. The method of claim 7, wherein the viscosity of the crosslinked fluid is greater than 100 cP at 100 sec⁻¹ at temperatures up to 150° F.

11. The method of claim 1, wherein the well is a gas, oil or geothermal well.

12. A method of fracturing a subterranean formation penetrated by a well comprising the steps of:
(a) forming an aqueous fluid comprising carboxymethyl tamarind powder; and
(b) pumping the fluid of step (a) down the well under sufficient pressure to create or enlarge a fracture within the subterranean formation.

13. The method of claim 12, wherein the aqueous fluid is a linear gel.

14. The method of claim 13, wherein the viscosity of the linear gel is between from about 5 to 30 cP at 511 sec⁻¹.

15. The method of claim 12, wherein the aqueous fluid is crosslinked or contains a crosslinking agent.

16. The method of claim 15, wherein the crosslinking agent contains boron, titanium, zirconium, or a mixture thereof.

17. The method of claim 15, wherein the viscosity of the crosslinked fluid is greater than 100 cP at 100 sec⁻¹ at temperatures up to 150° F.

18. The method of claim 12, wherein the fluid does not contain a friction reduction agent (other than the carboxymethyl tamarind powder).

19. A method of fracturing a subterranean formation penetrated by a gas, oil, or geothermal well comprising the steps of:
(a) forming an aqueous fluid comprising caboxyalkyl tamarind powder; and
(b) pumping the fluid of step (a) down the well under sufficient pressure to create or enlarge a fracture within the subterranean formation wherein:
(i) the fluid of step (a) is either a linear gel having a viscosity between from about 5 to 30 cP at 511 sec⁻¹ or is a crosslinked fluid having a viscosity greater than 100 cP at 100 sec⁻¹ at temperatures up to 150° F.; and
(ii) the amount of carboxyalkyl tamarind powder in the aqueous fluid is between from about 30 to about 100 ppt.

20. The method of claim 19, wherein the carboxyalkyl tamarind powder is carboxymethyl tamarind powder.
